(19) United States
(12) Patent Application Publication
(10) Pub. No.: US 2007/0283242 A1
(43) Pub. Date: Dec. 6, 2007

(54) Xml Processor and Xml Processing Method in System Having the Xml Processor

(76) Inventors: Kang-Chan Lee, Daejeon-city (KR); Jong-Hong Jeon, Daejeon-city (KR); Won-Suk Lee, Daejeon-city (KR); Seung-Yun Lee, Daejeon-city (KR); Ki-Shik Park, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 10/584,733

(22) PCT Filed: Oct. 29, 2004
(86) PCT No.: PCT/KR04/02759

§ 371 Date: May 25, 2007

(30) Foreign Application Priority Data
Dec. 26, 2003 (KR) 10-2003-0097243

(51) Int. Cl. G06F 15/00

(52) U.S. Cl. 715/513

(57) ABSTRACT

A significant drawback of the conventional XML parsers is that such parsers require relatively large software components, which causes load of a system that processes the XML documents to increase. Provided is an XML processor in which a part of XML processing is performed in a hardware manner based on independent hardware, thereby reducing computational load of a system and improving an XML processing speed, and an XML processing method performed in a system having the XML processor. The XML processor includes: a first memory storing software for performing an XML processing, variables, and values required to execute software; a hardware processing module performing a part of the XML processing in a hardware manner; a second memory employed by the hardware processing module; and a CPU controlling the XML processing by the software stored in the first memory. An XML processor in which a part of XML processing is performed in a hardware manner based on independent hardware, thereby improving an XML processing speed and reducing load of system compared to the conventional software processing.

### TECHNICAL FIELD

The present invention relates to XML (extensible mark-up language) processing, and more particularly, to an XML processor in which a part of XML processing is performed by a hardware, thereby not only reducing load of system but also improving an XML processing speed, and an XML processing method in a system having the XML processor.

### BACKGROUND ART

XML is a language for e-commerce, web portals, content services, and other information processing applications implemented on the Internet. The XML standard describes classes of data objects called XML documents and methods to process such XML documents.

The XML document is consisted of characters, some of which form character data, and some of which form a markup. The markup is consisted of a pair of a start tag and an end tag, and provides a description of the document layout and a logical structure among the XML documents.

Meanwhile, an XML parser may be viewed as a software library used to facilitate manipulation of XML documents. Most conventional XML parsers are configured to be compatible with XML grammar.

A significant drawback of the conventional XML parsers is that such parsers require relatively large software components, which causes load of a system that processes the XML documents to increase.

The importance of the Internet has been increased in the information-oriented era. In particular, usage of web has been rapidly increased in a variety of embedded systems, such as cellular phones, digital home electronics, telematics terminals, PDAs (Personal Digital Assistant), web TVs, and the like, besides typical PCs. However, such embedded systems typically have limited computing power and memory capacity compared to a PC. As a result, software-based conventional XML parsers are generally not suitable for use in embedded systems.

In the meantime, XML parsers suitable for non-PC-based devices for a specific use have been developed. However, such XML parsers for a specific use are also basically composed of a software library. Therefore, loads are still put on XML processing in non-PC-based devices, such that a method is required to process XML documents in an efficient manner.

### DISCLOSURE OF INVENTION

### Technical Problem

The present invention provides an XML processor in which a part of XML processing is performed in a hardware manner based on independent hardware, thereby improving an XML processing speed compared to the conventional software processing.

The present invention also provides an efficient method for XML processing in a device comprising a hardware-based XML processor and a software-based XML processor.

### Technical Solution

According to an aspect of the present invention, there is provided an XML processor in which a part of XML processing is performed in a hardware manner based on independent hardware, thereby reducing computational load of a system and improving an XML processing speed, and an XML processing method performed in a system having the XML processor.

### Advantageous Effects

The present invention provides an XML processor in which a part of XML processing is performed in a hardware manner based on independent hardware, thereby improving an XML processing speed and reducing computational load of a system compared to the conventional software processing.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the present invention is defined not by the detailed description of the invention but by the appended claims, and all differences within the scope of the present invention will be construed as being included in the present invention.

### DESCRIPTION OF DRAWINGS

The features and advantages of the present invention will become more apparent by describing in detail exemplary embodiments thereof with reference to the attached drawings in which:

FIG. 1 is a schematic diagram illustrating operations of an XML processor according to an embodiment of the present invention and conventional generalized XML parsers based on software;

FIG. 2 is a schematic diagram illustrating operations of an XML processor according to an embodiment of the present invention and conventional XML parsers for special use based on software;

FIG. 3 is a schematic diagram illustrating a capacity of an XML processor according to an embodiment of the present invention;

FIG. 4 illustrates an exemplary embodiment of an XML processor of the present invention;

FIG. 5 is a schematic diagram illustrating a method for realizing a memory management function in a hardware manner with respect to the XML processor of FIG. 4;

FIG. 6 is a flow chart describing procedures of assigning memory in the device of FIG. 5;

FIG. 7 is a flow chart describing procedures of re-assigning memory in the device of FIG. 5;

FIG. 8 is a flow chart describing procedures of returning memory in the device of FIG. 5;

FIG. 9 is a layer diagram illustrating a software architecture of a system that utilizes an XML processor according to an embodiment of the present invention;

FIG. 10 is a layer diagram illustrating a software architecture of a system for bulk XML processing; and

FIG. 11 is a flow chart describing an XML processing method according to an embodiment of the present invention.

### BEST MODE

The XML processor includes: a first memory storing software for performing an XML processing, variables, and values required to execute software; a hardware processing module performing a part of the XML processing in a hardware manner; a second memory employed by the hardware processing module; and a CPU controlling the XML processing by the software stored in the first memory. An XML processor in which a part of XML processing is performed in a hardware manner based on independent hardware, thereby improving an XML processing speed and reducing load of system compared to the conventional software processing.

### Mode for Invention

The present invention will now be described in more detail with reference to the accompanying drawings, in which exemplary embodiments of the invention are shown.

An embodiment of the present invention provides an XML processor that supports XML processing on a central processing unit (CPU) of a system to be done more efficiently.

Conventional XML processing is totally realized in a software manner. When performing large amounts of XML processing, the conventional XML processing imposes a lot of computing load on a CPU. This causes the performance of a system to be reduced and also influences other functions of the system, resulting in economical loss.

In embedded systems, such as cellular phones, digital home electronics, telematics terminals, PDAs, and so on, which have a relatively low CPU performance compared to a PC, XML processing becomes relatively huge load.

An embodiment of the present invention provides high-speed XML processing based on independent hardware, which can solve the problem described above and can be suitably applied to systems according to its characteristics respectively

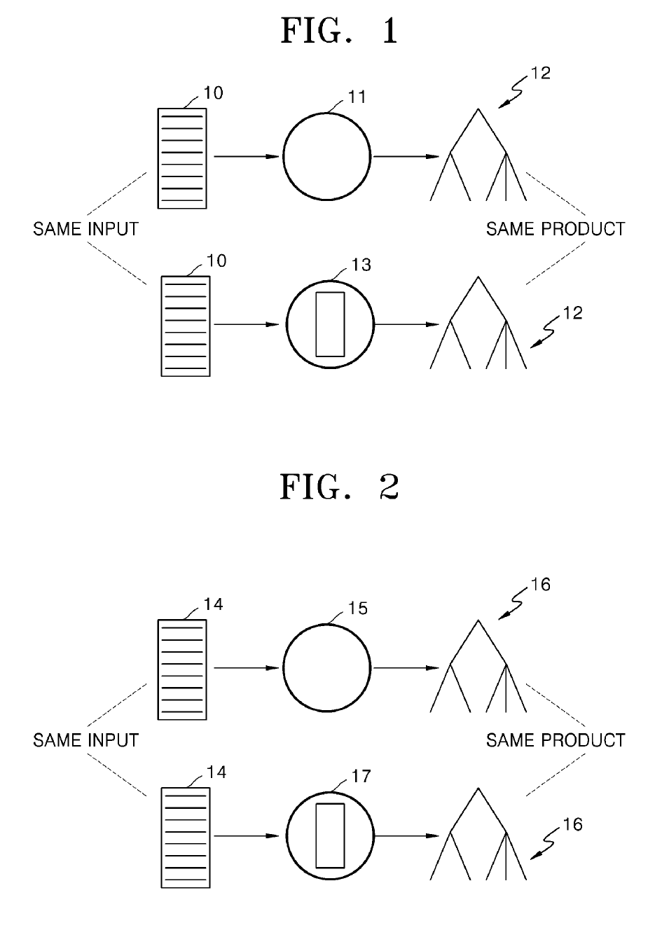

FIG. 1 is a schematic diagram illustrating operations of an XML processor according to an embodiment of the present invention and conventional generalized XML parser based on software. As shown in FIG. 1, an XML processor 13 according to the embodiment of the present invention and software-based conventional generalized XML parsers 11 process the same input XML document 10 and generate the same product 12.

The software-based conventional generalized XML parsers 11 fully support an XML version 1.0 of W3C (World Wide Web Consortium) such as an MSXML (Microsoft XML Parser) of Microsoft, an XML for C++ and an XML for java of IBM, a JAXP (Java API for XML Processing) of SunMicroSystems, etc.

The XML processor 13 according to the embodiment of the present invention performs a part of XML processing, e.g., a memory management function necessary for parsing, an XML DTD(Data Type Definition), a state machine with respect to an XML schema, etc. in a hardware manner. The speed of the XML processor 13 is faster than that of software-based conventional generalized XML parsers 11.

The XML processor 13 reduces computational load on a CPU, thereby helping a CPU to perform a processing of XML documents more naturally and to perform other processing more efficiently.

FIG. 2 is a schematic diagram illustrating operations of an XML processor according to an embodiment of the present invention and conventional XML parsers for special use based on software.

As shown in FIG. 2, the XML processor 13 according to the embodiment of the present invention and software-based conventional XML parsers 15 for special use process the same input XML document 14 and generate the same product 16.

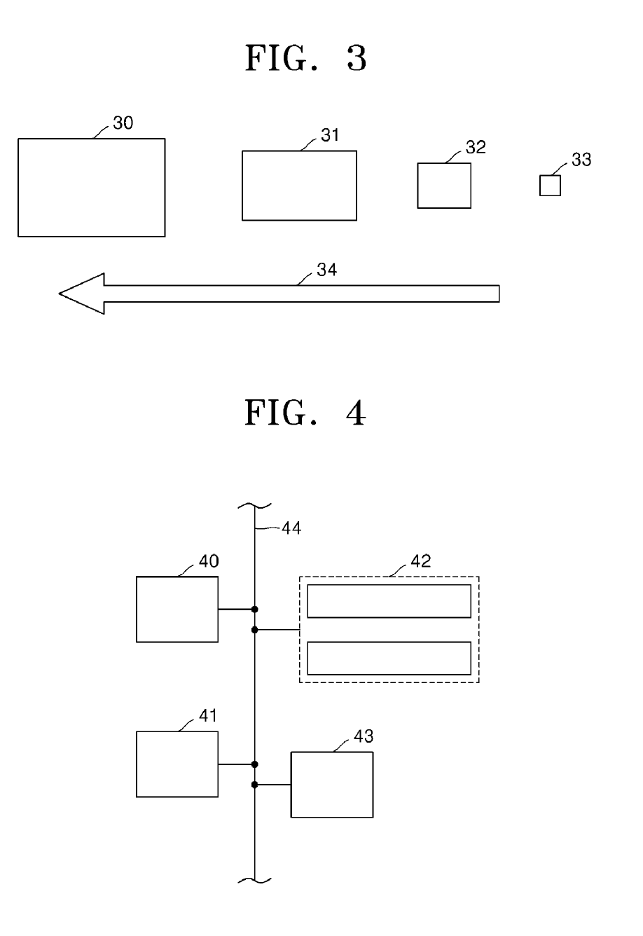

FIG. 3 is a schematic diagram illustrating a capacity of an XML processor according to an embodiment of the present invention. Referring to FIG. 3, it is easily understood that the processing capacity of the XML processor according to the embodiment of the present invention is variably adaptable according to the request to the each of systems.

In FIG. 3, an arrow 34 indicates a direction in which the processing capacity of the XML processor increases. Referring to FIG. 3, it can be seen that the XML processor according to one embodiment of the present invention can have be designed according to the characteristics and processing capacity of system applied.

FIG. 4 illustrates an exemplary embodiment of an XML processor according to the present invention. An XML processor 13 shown in FIG. 4 comprises a CPU 40 that generally controls the XML processor 13, a memory 41 that stores software for performing a specific function of the CPU 40, variables, and values required to execute software instructions, a hardware processing module 42 that performs a part of XML processing in a hardware manner, and a memory 43 used in the hardware processing nodule 42. A bus 44 that receives and transmits data connects the above components.

FIG. 4 shows that a specific function among the XML processing functions can be realized in a hardware manner. For example, a memory management function used in parsing, i.e., processing of assigning, returning, and reassigning memory, influences the most the performance of software parsers.

Referring to FIG. 4, the XML processor according to the embodiment of the present invention can realize the memory management function in a hardware manner in order to improve the performance of XML processing. The XML processor according to the embodiment of the present invention can realize an XML DTD and a state machine with respect to an XML schema, which are frequently used in XML processing, in a hardware manner, in addition to the memory management function.

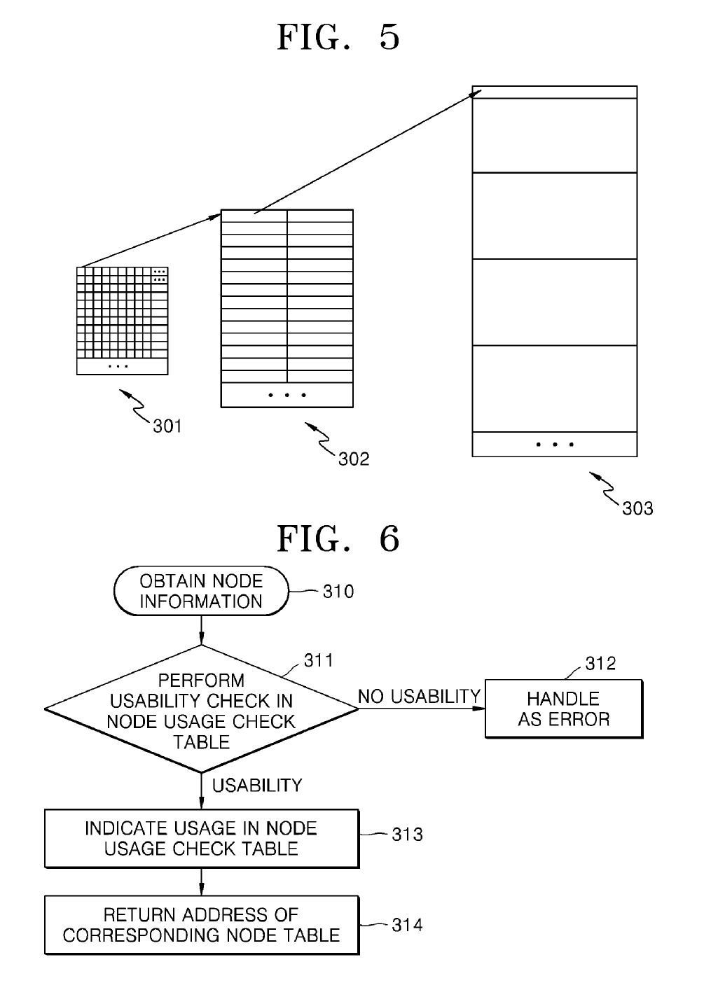

FIG. 5 is a schematic diagram illustrating a method for realizing a memory management function in a hardware manner with respect to the XML processor 13 of FIG. 4. XML parsers compile an XML document into a tree structure, providing hierarchical information with which application programs are able to navigate.

XML elements are expressed as nodes, which are correlated and tree-based. Assignment, reassignment, and return of memory have to be processed for the nodes. What are considered for memory management with respect to the node are to select information to be maintained at the node and to process information having flexible data size.

Information that the nodes have to store may be defined according to DOM (Document Object Model), one of W3C standards for XML document processing. DOM is a standard supported by most XML parsers so that it can be easily linked with the existing parsers of various types.

Referring to DOM, information that the nodes have to store includes a node name, a node value, a node type, a parent node, a child node, an eldest child node, a youngest child node, a preceding sibling, a following sibling, and an attribute value. More information, in this regard is presented in DOM standards.

The information having flexible data size is a node value when a node type is PCDATA. Sizes of a node name, a node type, and an attribute value having a data value are hardly so flexible that there are few problems even if sizes of them are processed as being fixed. Other information is pointer information and thus is enough to store only address information.

In order to satisfy the above characteristics, the memory management function using hardware may be composed of a node usage check table 301, a node table 302, and a memory 303 that maintains actual data, as shown in FIG. 5. The node usage check table 301 is divided into several blocks having different sizes depending on the data size that the nodes have to store. Fields in the blocks indicate whether to use the corresponding node table 302. The node table 302 manages the whole information that the nodes have to store, i.e., a node name, a node type, a parent node, a child node, and the like. However, the node table 302 stores not actual values but addresses of the memory 303. Every field of the node table 302 has a fixed size.

The memory 303 may be RAM (Random Access Memory) and is used for storing actual values. It is possible to realize the node usage check table 301 and the node table 302 as an ASIC (Application-Specific Integrated Circuit).

The node usage check table 301 and the node table 302 shown in FIG. 5 have a fixed correlation. To be more specific, if locations of a memory to be used in the node usage check table 301 are determined, locations of a block to be used in the node table 302 are automatically determined. The node table 302 does not store actual values but stores addresses of the memory 303 having actual information. The node table 302 may be mapped to fixed locations in order to obtain maximum performance.

However, there is little information having actual values and little information having large variability on the node table 302. Therefore, if the memory has a proper size, memory will not be greatly consumed. The addresses to be stored in the node table 302 may be information of other fields (i.e., other nodes) in the node table 302.

FIG. 6 is a flow chart describing procedures of assigning memory in the device of FIG. 5. First, node information including the size of memory to be assigned is obtained in Operation 310. The node information including the size of memory to be assigned is required to assign memory necessary for a DOM tree during XML parsing. Based on the node information, whether there is enough memory to be assigned for node referring to node usage check table 301 in operation 311. If there is enough memory, memory usage is indicated in the node usage check table 301 in operation 313. If not enough memory, error processing is done in operation 312.

The node usage check table 301 and the node table 302 have a fixed correlation. Hence, if memory locations to be used in the node usage check table 301 are determined, addresses of an area to be used on the node table 302 are automatically obtained. The address of the corresponding node table 302 is returned in Operation 314 to complete the assignment of memory in Operation 314.

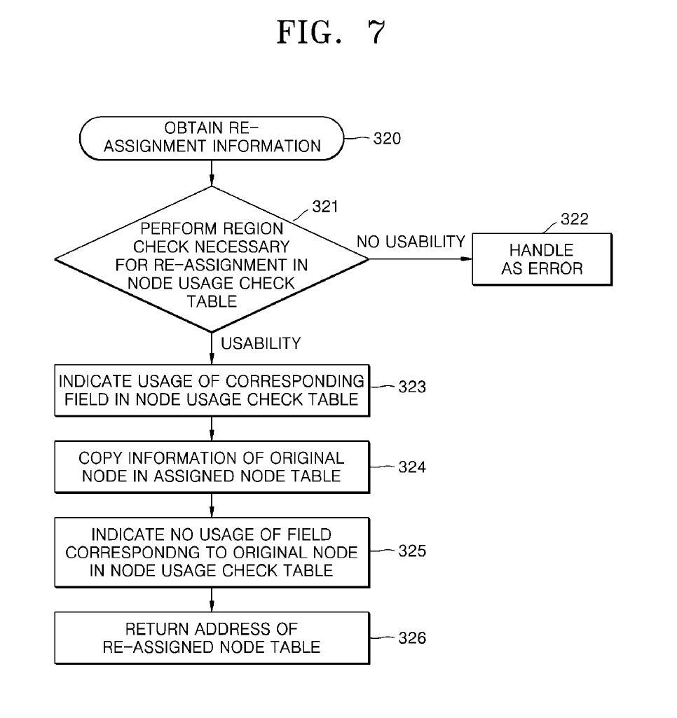

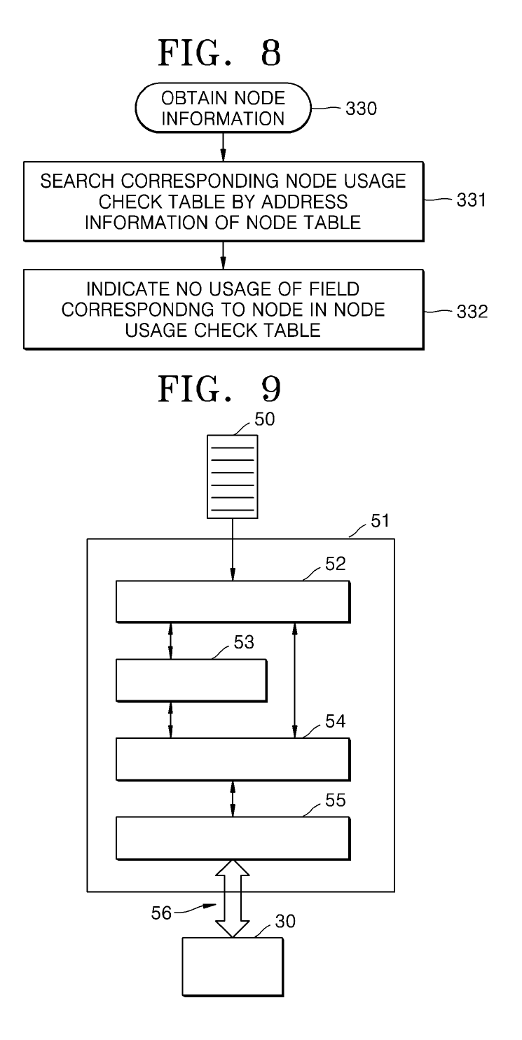

FIG. 7 is a flow chart describing procedures of re-assigning memory in the device of FIG. 5. Re-assignment of memory refers to assignment of memory having a proper size in order to handle bigger data or smaller data.

First, re-assignment information is obtained in Operation 320. The re-assignment information includes the node information being used at the present time and the desired size of memory. Based on the re-assignment information, the node usage check table 301 performs a region check necessary for the re-assignment and determines whether to re-assign memory in Operation 321.

If re-assignment of memory is available, memory usage is indicated with respect to a newly used part in the node usage check table 302 in Operation 323, and information of the original node is copied in the assigned node table 302 in Operation 324. Thereafter, since what has been used is not necessary, unusage is indicated with respect to the field that corresponds to the original node in the node usage check table 301 in Operation 325. The address of the re-assigned node table 302 is returned in Operation 326.

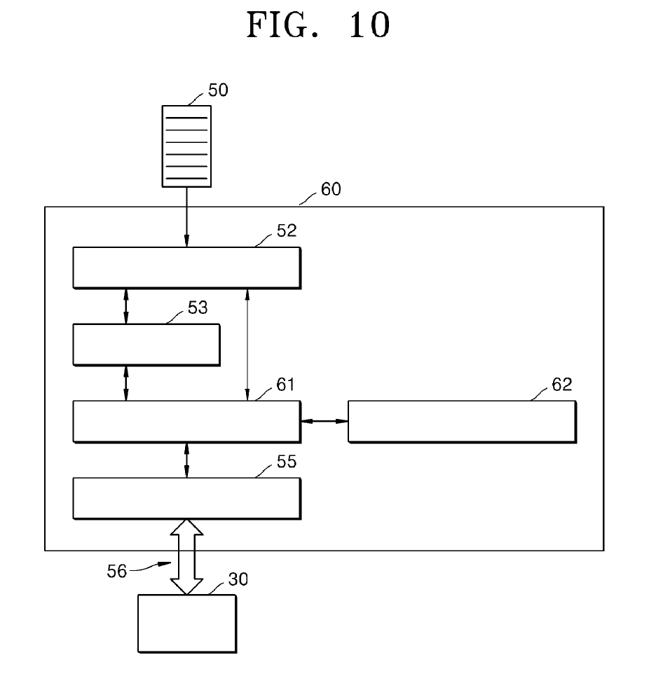

FIG. 8 is a flow chart describing procedures of returning memory in the device of FIG. 5. First, usage node information is obtained in Operation 320. A corresponding node usage check table 301 is searched using the usage node information 330 in Operation 331. Unusage is indicated with respect to the field that corresponds to node in the searched node usage check table 301 in Operation 332.

FIG. 9 is a layer diagram illustrating a software architecture of a system that utilizes an XML processor according to an embodiment of the present invention. A variety of methods are used for an interface 56 between the system 51 that utilizes the XML processor 13 according to one embodiment of the present invention and the XML processor 13. For example, standard methods such as PCI (Peripheral Component Interface), USB (Universal Serial Bus), etc., are used. In consideration of speed and stability of the interface. As the system 51, a variety of embedded systems, such as cellular phones, digital home electronics, telematics terminals, PDAs, web TVs, and the like are used.

A device driver 55 of the system 51 is a program with the lowest level for transmitting and receiving data with the XML processor 13. An XML parser API 54 (Application Programming Interface) is upper the device driver 55. An application program 52 performs XML processing using the XML parser API 54. A language application layer 53 is intended to maintain independence of language when an application program is developed. The language application layer 53 has to be supported by its own language.

The XML parser API 54 is stored in a memory (not shown) of the system 51, and can be realized using a software program, which is executed by a processor (not shown). The XML parser API 54 supports XML grammar suitable for processing an XML document. The XML processor 13 performs an XML document, as shown in FIG. 4, using a part of the XML processing, e.g., the hardware processing module 42 that embeds the memory management function and the memory 43, thereby improving an XML processing speed. The memory management function of the hardware processing module 42 in the XML processor 13 is shown and described with reference to FIGS. 5 through 8.

FIG. 10 is a layer diagram illustrating a software architecture of a system for large amounts of XML processing. System 60 shown in FIG. 10 has a similar configuration to that of the system 50 shown in FIG. 5, and further includes a software XML parser 62.

In order to more effectively process XML information, if a software processing is advantageous depending on the processing condition, the software XML parser 62 processes XML information, if not, the XML processor 13 processes XML information.

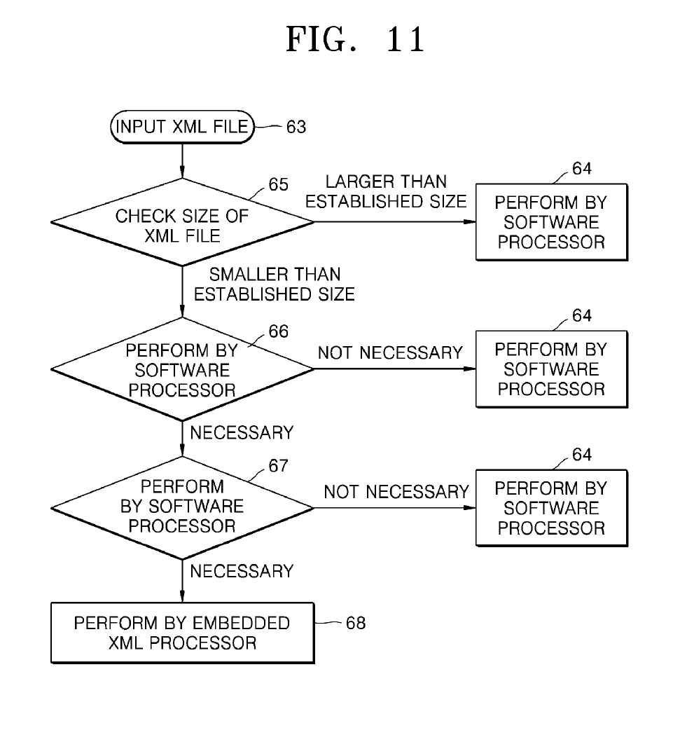

An XML parser API layer 61 determines such processing division. The processing condition and procedure are described referring to FIG. 11.

FIG. 11 is a flow chart describing an XML processing method according to an embodiment of the present invention. FIG. 11 shows an XML processing method performed in a system having the XML processor according to the embodiment of the present invention described with reference to FIGS. 4 through 6 and a software-based XML processor.

First, the size of an input XML file is checked in Operation 65 because processing an XML file having a size beyond a specific unit influences the general performance of the XML processor having limited memory. Accordingly, in this case, the XML file is processed using the software XML parser 62 in Operation 64.

If the size of an input file is smaller than the established size, it is checked whether a parsing tree is necessary as a result of XML processing in Operation 66. This is necessary because the software processing is advantageous when there is little performance difference between the software XML parser and the XML processor.

If a tree is not necessary as a result of the XML processing, the software XML parser processes an XML file in Operation 64.

If a tree is necessary as a result of the XML processing, it is checked whether fast processing is necessary in Operation 67. This is necessary because a file not necessary for fast processing is performed using the software processor, and a file necessary for fast processing is performed using the XML processor.

A file not necessary for fast processing is performed using the software processor in Operation 64, and a file necessary for fast processing is performed using the XML processor in Operation 68.

The XML processor according to the embodiments of the present invention can be applied to various systems indispensably requiring XML processing, and performs a part of the XML processing, e.g., a memory management function necessary for parsing, an XML DTD, a state machine with respect to an XML schema, etc. in a hardware manner based on independent hardware, thereby improving an XML processing speed compared to the conventional software processing.

A system to which the XML processor is applied does not unnecessary load on CPU, thereby greatly improving the system performance, and accordingly, small-sized embedded systems having limited computing power can perform a XML processing.

The XML processor according to the embodiments of the present invention can be equally applied to systems that greatly require high performance of XML processing and systems overloaded by XML processing and not requiring high performance of the XML processing.

That is, the XML processor according to the embodiments of the present invention can be employed in an e-commerce server requiring bulk XML processing and in small-sized embedded systems such as digital home electronics, telematics terminals, PDAs, and the like.

In general, a parser used in small-sized embedded systems having limited computing power supports more than one designated XML DTD or schema, or supports a part of the XML standards in order to reduce overload because of XML processing. However, the above methods may also use the XML processor according to the embodiments of the present invention to obtain a more natural XML processing.

The XML processor according to the embodiments of the present invention may have a PCI card type for a server, a stick type with USB for a general tablet PC, and a SoC (System on Chip) type for a smart phone or digital home electronics, etc. Such various types indicate that the XML processor according to the embodiments of the present invention can be suitable for the memory capacity and the characteristics of various systems. Also, the interface between the system and the XML processor is suitably to the characteristics of each system.

1. An XML processor comprising:
a first memory storing software for performing an XML processing, variables, and values required to execute software;
a hardware processing module performing a part of the XML processing in a hardware manner;
a second memory employed by the hardware processing module; and
a CPU controlling the XML processing by the software stored in the first memory.

2. The XML processor according to claim 1, wherein the hardware processing module performs a memory management function used in XML parsing, i.e., assignment, return, and reassignment of memory among XML processing functions.

3. The XML processor according to claim 2, wherein the hardware processing module processes assignment, reassignment, and return of memory with respect to XML elements which are expressed as nodes and a tree relation between the nodes, the module comprising:
a node usage check table divided into several blocks, each block indicating whether to use a corresponding node table;
a node table managing the whole information that each node has to store, i.e., a node name, a node type, a parent node, a child node, and the like; and
a node memory storing actual content of every component of the node table.

4. The XML processor according to claim 3, wherein the node table has addresses in which every component on the node memory is respectively stored.

5. The XML processor according to claim 1, wherein the hardware processing module performs an XML DTD processing.

6. The XML processor according to claim 1, wherein the hardware processing module performs a state machine of an XML schema.

7. An XML processing method performed in a system having an independent hardware-based first XML processor and a software-based second XML processor, the method comprising:
checking a size of an XML file to be processed;
performing an XML processing by the second XML processor if a size of the XML file to be processed is larger than an established size; and
performing an XML processing by the first XML processor if a size of the XML file to be processed is not larger than the established size.

8. The method according to claim 7, further comprising:
checking whether establishment of a tree is necessary after the XML processing;
performing the XML processing by the second XML processor if the establishment of the tree is not necessary; and
performing the XML processing by the first XML processor if the establishment of the tree is necessary.

9. The method according to claim 7, further comprising:
checking whether a fast processing is necessary;
performing the XML processing by the second XML processor if the fast
processing is not necessary; and
performing the XML processing by the first XML processor if the fast processing is necessary.
